(19) United States
(12) Patent Application Publication
(10) Pub. No.: US 2021/0280878 A1
(43) Pub. Date: Sep. 9, 2021

(54) RESIN FRAME EQUIPPED MEMBRANE ELECTRODE ASSEMBLY AND POWER GENERATION CELL

(71) Applicant: HONDA MOTOR CO., LTD., TOKYO (JP)

(72) Inventors: Yusuke WADA, WAKO-SHI (JP); Taichi KITAGAWA, WAKO-SHI (JP); Ryo TAKANO, WAKO-SHI (JP)

(21) Appl. No.: 17/191,087

(22) Filed: Mar. 3, 2021

(30) Foreign Application Priority Data
Mar. 5, 2020 (JP) 2020-037598

(51) Int. Cl. H01M 8/0273

(52) U.S. Cl. CPC H01M 8/0273

(57) ABSTRACT

A power generation cell includes a resin frame equipped membrane electrode assembly. An inclined surface is formed on each of four side parts of the inner peripheral end of a resin frame member. The inclined surface is inclined inward from one surface of the resin frame member toward the other surface of the resin frame member. In a side part and a corner part of the inner peripheral end that are adjacent to each other, a side surface serving as a step is formed between the inclined surface and a first plane surface part at the corner part of the resin frame member.

### CROSS-REFERENCE TO RELATED APPLICATION

This application is based upon and claims the benefit of priority from Japanese Patent Application No. 2020-037598 filed on Mar. 5, 2020, the contents of which are incorporated herein by reference.

### BACKGROUND OF THE INVENTION

### Field of the Invention

The present invention relates to a resin frame equipped membrane electrode assembly and a power generation cell.

### Description of the Related Art

For example, a power generation cell is formed by sandwiching a resin frame equipped membrane electrode assembly (resin frame equipped MEA) between a pair of separators. The resin frame equipped MEA includes a membrane electrode assembly (MEA), and a quadrangular annular resin member. The membrane electrode assembly includes an anode provided on one surface of the electrolyte membrane, and a cathode provided on the other surface of the electrolyte membrane. The resin frame member is provided on an outer peripheral portion of the membrane electrode assembly.

An inner peripheral end of the resin frame member is provided around an outer peripheral portion of the MEA. In the state where the inner peripheral end of the resin frame member is disposed between an outer peripheral portion of the anode and an outer peripheral portion of the cathode. The resin frame member is joined to the electrolyte membrane. In the resin frame member, in the case where the inner peripheral end has a quadrangular shape in cross section in the thickness direction, a gap is formed inside the inner peripheral end of the resin frame member (portion where the electrolyte membrane and the electrode are spaced from each other) is formed. In the resin frame equipped MEA, power generation is not performed in an area where the gap is formed inside the inner peripheral end of the resin frame member. Therefore, the power generation efficiency of the power generation cell is decreased.

For example, Japanese Laid-Open Patent Publication No. 2018-097917 discloses a resin frame equipped MEA where the size of the gap inside the inner peripheral end of the resin frame member is reduced. An inclined surface is formed in the inner peripheral end of the resin frame member of the resin frame equipped MEA. The inclined surface is inclined inward from a surface closer to the electrolyte membrane toward a surface opposite to the electrolyte membrane.

### SUMMARY OF THE INVENTION

However, in the above described resin frame member, forming of the inclined surface at the corner part (quadrangular corner part) of the inner peripheral end of the resin frame member is difficult in comparison with forming of the inclined surface in the side part of the inner peripheral end of the resin frame member. Therefore, the production efficiency of producing the resin frame member tends to be low.

The present invention has been made taking such a problem into account, and an object of the preset invention is to provide a resin frame equipped membrane electrode assembly and a power generation cell in which it is possible to suppress decrease in the production efficiency of producing a resin frame member, and improve the power generation efficiency.

According to one aspect of the present invention, a resin frame equipped membrane electrode assembly is provided. The resin frame equipped membrane electrode assembly includes a membrane electrode assembly and a resin frame member. The membrane electrode assembly includes an electrolyte membrane, a first electrode provided on one surface of the electrolyte membrane, a second electrode provided on the other surface of the electrolyte membrane. The resin frame member is provided on an outer peripheral portion of the membrane electrode assembly. An inner peripheral end of the resin frame member is formed in a quadrangular annular shape around the outer peripheral portion of the membrane electrode assembly and disposed between an outer peripheral portion of the first electrode and an outer peripheral portion of the second electrode. An inclined surface is formed on each of four side parts of the inner peripheral end. The inclined surface is inclined inward from one surface of the resin frame member toward the other surface of the resin frame member. In a side part and a corner part of the inner peripheral end that are adjacent to each other, a step is formed between the inclined surface and a portion positioned at the corner part, of the one surface of the resin frame member.

According to another aspect of the present invention, a power generation cell is provided. The power generation cell includes the above-described resin frame equipped membrane electrode assembly, and a first separator and a second separator provided on both sides of the resin frame equipped membrane electrode assembly, respectively.

In the present invention, the inclined surface is formed on each of the four side parts of the inner peripheral portion of the resin frame member. That is, the thickness of the inner peripheral end of the resin frame member is reduced inward. In the structure, it is possible to reduce the size of the gap inside the inner peripheral end of the resin frame member. Thus, it is possible to improve the power generation efficiency. Further, in the side part and the corner part of the inner peripheral end that are adjacent to each other, the step is formed between the portion positioned at the corner part and the inclined surface, of the one surface of the resin frame member. In the structure, since no inclined surfaces need to be formed at the four corners of the inner peripheral end of the resin frame member, it is possible to suppress decrease in the production efficiency of producing the resin frame member.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view with partial omission including a power generation cell according to an embodiment of the present invention;

FIG. 2 is a cross sectional view taken along a line II-II in FIG. 1;

FIG. 3A is a perspective view showing a resin frame member in FIG. 2 and FIG. 3B is a cross sectional view taken along a line IIIB-IIIB in FIG. 3A; and

FIG. 4 is a perspective view showing a resin sheet before an inclined surface is processed.

### DESCRIPTION OF THE PREFERRED EMBODIMENTS

Hereinafter, a preferred embodiment of a resin frame equipped membrane electrode assembly and a power generation cell according to the present invention will be described with reference to the accompanying drawings.

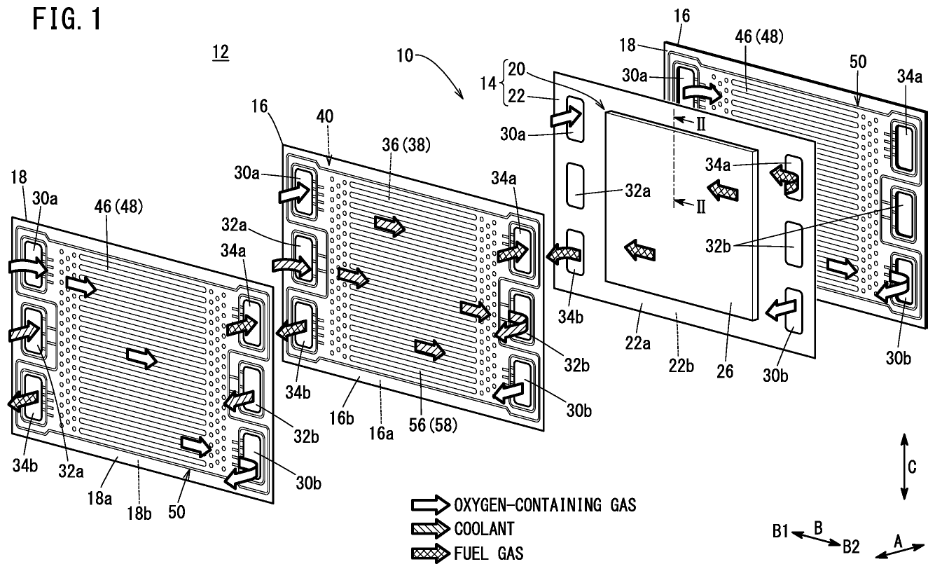

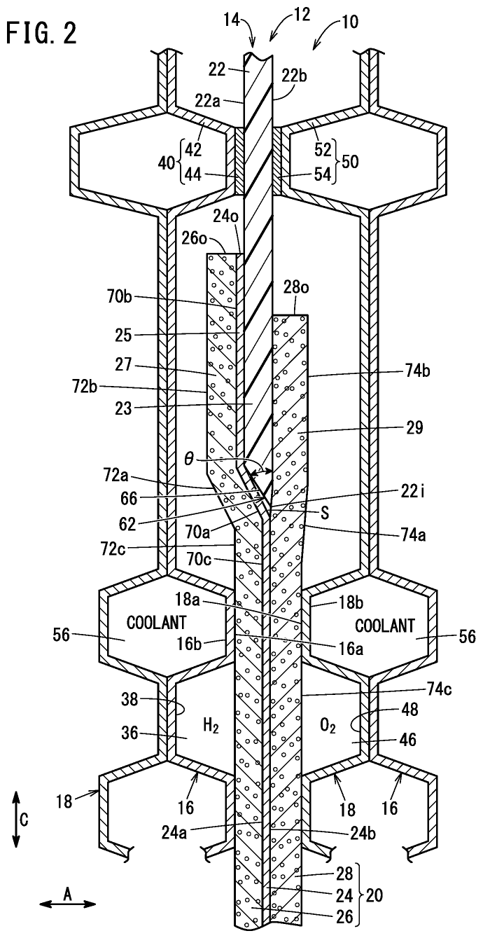

As shown in FIGS. 1 and 2, a plurality of power generation cells 10 are stacked together in a thickness direction of the power generation cells 10 (direction indicated by an arrow A) to form a fuel cell stack 12. For example, the fuel cell stack 12 is used as an in-vehicle fuel cell stack mounted in a fuel cell electric automobile (not shown). It should be noted that the stacking direction of the plurality of the power generation cells 10 may be oriented in either a horizontal direction, or the gravity direction.

In FIG. 1, the power generation cell 10 has a laterally elongated rectangular shape. It should be noted that the power generation cell 10 may have a longitudinally elongated rectangular shape. As shown in FIGS. 1 and 2, the power generation cell 10 includes a resin frame equipped membrane electrode assembly (hereinafter referred to as the “resin frame equipped MEA 14”), and a first separator 16 and a second separator 18 provided on both sides of the resin frame equipped MEA 14, respectively. The resin frame equipped MEA 14 includes a membrane electrode assembly (hereinafter referred to as the “MEA 20”), and a resin frame member 22 (resin frame part, resin film) provided on an outer peripheral portion of the MEA 20.

In FIG. 2, the MEA 20 includes an electrolyte membrane 24, an anode 26 (first electrode) provided on one surface 24a of the electrolyte membrane 24, and a cathode 28 (second electrode) provided on the other surface 24b of the electrolyte membrane 24. For example, the electrolyte membrane 24 is a solid polymer electrolyte membrane (cation ion exchange membrane). For example, the sold polymer electrolyte membrane is a thin membrane of perfluorosulfonic acid containing water. A fluorine based electrolyte may be used as the electrolyte membrane 24. Alternatively, an HC (hydrocarbon) based electrolyte may be used as the electrolyte membrane 24. The electrolyte membrane 24 is held between the anode 26 and the cathode 28.

Though not shown in details, the anode 26 includes a first electrode catalyst layer joined to one surface 24a of the electrolyte membrane 24, and a first gas diffusion layer stacked on the first electrode catalyst layer. The first electrode catalyst layer is formed by depositing porous carbon particles uniformly on the surface of the first gas diffusion layer, and platinum alloy is supported on surfaces of the carbon particles.

The cathode 28 includes a second electrode catalyst layer joined to the other surface 24b of the electrolyte membrane 24, and a second gas diffusion layer stacked on the second electrode catalyst layer. The second electrode catalyst layer is formed by depositing porous carbon particles uniformly on the surface of the second gas diffusion layer, and platinum alloy is supported on surfaces of the carbon particles. Each of the first gas diffusion layer and the second gas diffusion layer comprises a carbon paper, a carbon cloth, etc.

The surface size (outer size) of the anode 26 is larger than the surface size of the cathode 28. The surface size of the electrolyte membrane 24 is the same as the surface size of the anode 26. The outer peripheral end 26o of the anode 26 is positioned outside the outer peripheral end 28o of the cathode 28. In the surface direction of the electrolyte membrane 24 (in the direction indicated by the arrow C in FIG. 2), the outer peripheral end 24o of the electrolyte membrane 24 is disposed at the same position as the outer peripheral end 26o of the anode 26.

The surface size of the anode 26 may be smaller than the surface size of the cathode 28. In this case, the outer peripheral end 26o of the anode 26 is positioned inside the outer peripheral end 28o of the cathode 28. The surface size of the electrolyte membrane 24 may be the same as the surface size of the anode 26. Alternatively, the surface size of the electrolyte membrane 24 may be the same as the surface the cathode 28. The surface size of the anode 26 may be the same as the surface size of the cathode 28. In this case, in the surface direction of the electrolyte membrane 24, the outer peripheral end 24o of the electrolyte membrane 24, the outer peripheral end 26o of the anode 26 and the outer peripheral end 28o of the cathode 28 are present at the same position.

The resin frame member 22 is a single frame shaped sheet provided around the outer peripheral portion of the MEA 20. The resin frame member 22 is an electrically insulating member. Examples of materials of the resin frame member 22 include PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin. The details of the resin frame member 22 will be described later.

In FIG. 1, each of the first separator 16 and the second separator 18 has a rectangular shape (quadrangular shape). Each of the first separator 16 and the second separator 18 is formed by press forming of a metal thin plate to have a corrugated shape in cross section and a wavy shape on the surface. For example, the metal plate is a steel plate, a stainless steel plate, an aluminum plate, a plated steel plate, or a metal plate having an anti-corrosive surface by surface treatment. It should be noted that each of the first separator 16 and the second separator 18 may be made of carbon, etc. In the state where the first separator 16 and the second separator 18 are stacked together, the outer peripheral portions of the first separator 16 and the second separator 18 are joined together by welding, brazing, crimping, etc.

At one end of the power generation cell 10 in the long side direction B (end in the direction indicated by the arrow B1), an oxygen-containing gas supply passage 30a, a coolant supply passage 32a, and a fuel gas discharge passage 34b are arranged in the short side direction (direction indicated by the arrow C) of the power generation cells 10. An oxygen-containing gas is supplied through the oxygen-containing gas supply passage 30a. A coolant (e.g., pure water, ethylene glycol, oil) is supplied through the coolant supply passage 32a in the direction indicated by the arrow A. A fuel gas (e.g., hydrogen-containing gas) is discharged through the fuel gas discharge passage 34b in the direction indicated by the arrow A.

At the other end of the power generation cell 10 in the direction indicated by the arrow B (end in the direction indicated by the arrow B2), a fuel gas supply passage 34a, a coolant discharge passage 32b, and an oxygen-containing gas discharge passage 30b are arranged in the direction indicated by the arrow C. The fuel gas is supplied through the fuel gas supply passage 34a in the direction indicated by the arrow A. The coolant is discharged through the coolant discharge passage 32b in the direction indicated by the arrow A. The oxygen-containing gas is discharged through the oxygen-containing gas discharge passage 30b in the direction indicated by the arrow A.

The sizes, the positions, the shapes, and the numbers of the oxygen-containing gas supply passage 30a, the oxygen-containing gas discharge passage 30b, the fuel gas supply passage 34a, the fuel gas discharge passage 34b, the coolant supply passage 32a, and the coolant discharge passage 32b are not limited to the embodiment of the present invention, and may be determined as necessary depending on the required specification.

As shown in FIGS. 1 and 2, the first separator 16 has a fuel gas flow field 36 on its surface 16a facing the MEA 20. The fuel gas flow field 36 is connected to the fuel gas supply passage 34a and the fuel gas discharge passage 34b. The fuel gas flow field 36 includes a plurality of fuel gas flow grooves 38 extending in the direction indicated by the arrow B. Each of the fuel gas flow grooves 38 may extend in a wavy pattern in the direction indicated by the arrow B.

In FIG. 1, a first seal 40 is provided on the first separator 16, for preventing leakage of fluid (the fuel gas, the oxygen-containing gas, and the coolant) from positions between the resin frame equipped MEA 14 and the first separator 16. The first seal 40 is formed along the outer peripheral portion of the first separator 16, and provided around the fluid passages (oxygen-containing gas supply passage 30a, etc.). The first seal 40 extends straight as viewed in the separator thickness direction (direction indicated by the arrow A). It should be noted that the first seal 40 may extend in a wavy pattern as viewed in the separator thickness direction.

In FIG. 2, the first seal 40 includes a first metal bead 42 formed integrally with the first separator 16, and a first resin member 44 provided on the first metal bead 42. The first metal bead 42 protrudes from the first separator 16 toward the resin frame member 22. The first metal bead 42 has a trapezoidal shape in lateral cross section which is tapered (narrowed) in a protruding direction in which the first metal bead 42 protrudes. The first resin member 44 is an elastic member fixed to the protruding end surface of the first metal bead 42 by printing or coating, etc. For example, polyester fiber may be used as the first resin member 44.

As shown in FIGS. 1 and 2, the second separator 18 has an oxygen-containing gas flow field 46 on its surface 18a facing the MEA 20. The oxygen-containing gas flow field 46 is connected to the oxygen-containing gas supply passage 30a and the oxygen-containing gas discharge passage 30b. The oxygen-containing gas flow field 46 includes a plurality of oxygen-containing gas flow grooves 48 extending in the direction indicated by the arrow B. Each of the oxygen-containing gas flow grooves 48 may extend in a wavy pattern in the direction indicated by the arrow B.

A second seal 50 is provided on the second separator 18, for preventing leakage of fluid (the fuel gas, the oxygen-containing gas, and the coolant) from positions between the resin frame equipped MEA 14 and the second separator 18. The second seal 50 is formed along the outer peripheral portion of the second separator 18, and provided around the fluid passages (oxygen-containing gas supply passage 30a, etc.). The second seal 50 extends straight as viewed in the separator thickness direction (direction indicated by the arrow A). It should be noted that the second seal 50 may extend in a wavy pattern as viewed in the separator thickness direction.

In FIG. 2, the second seal 50 includes a second metal bead 52 formed integrally with the second separator 18, and a second resin member 54 provided on the second metal bead 52. The second metal bead 52 protrudes from the second separator 18 toward the resin frame member 22. The second metal bead 52 has a trapezoidal shape in lateral cross section which is tapered (narrowed) in a protruding direction in which the second metal bead 52 protrudes. The second resin member 54 is an elastic member fixed to the protruding end surface of the second metal bead 52 by printing or coating, etc. For example, polyester fiber may be used as the second resin member 54.

The first seal 40 and the second seal 50 are disposed in a manner that the first seal 40 and the second seal 50 are overlapped with each other as viewed in the separator thickness direction. Therefore, in the state where a tightening load (compression load) is applied to the fuel cell stack 12, each of the first metal bead 42 and the second metal bead 52 is elastically deformed (deformed by compression). Further, in this state, the protruding end surface (the first resin member 44) of the first seal 40 contacts one surface 22a of the resin frame member 22 in an air-tight and liquid-tight manner, and the protruding end surface (second resin member 54) of the second seal 50 contacts the other surface 22b of the resin frame member 22 in an air-tight and liquid-tight manner.

The first resin member 44 may be provided on one surface 22a of the resin frame member 22 instead of the first metal bead 42. The second resin member 54 may be provided on the other surface 22b of the resin frame member 22 instead of the second metal bead 52. Further, at least one of the first resin member 44 and the second resin member 54 may be omitted. The first seal 40 and the second seal 50 may not be the metal bead seals as described above. The first seal 40 and the second seal 50 may be in the form of elastic rubber seal members.

In FIGS. 1 and 2, a coolant flow field 56 is provided between the surface 16b of the first separator 16 and the surface 18b of the second separator 18. The coolant flow field 56 is connected to the coolant supply passage 32a and the coolant discharge passage 32b. The coolant flow field 56 is formed on the back surface of the oxygen-containing gas flow field 46 and the back surface of the fuel gas flow field 36.

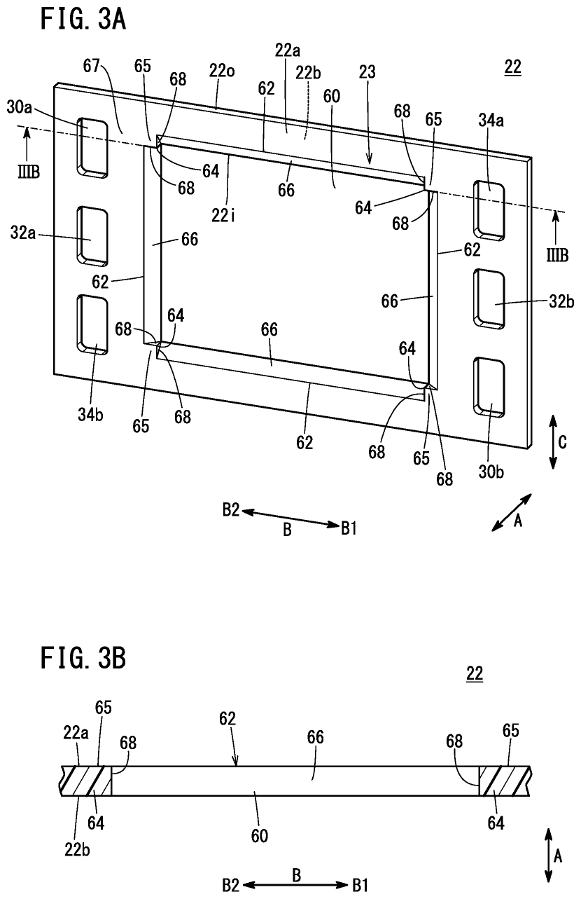

As shown in FIGS. 1 and 3A, the resin frame member 22 is formed in a quadrangular annular shape. That is, in FIG. 3A, a quadrangular opening 60 is formed at the central portion of the resin frame member 22. Therefore, as shown in FIGS. 1 to 3A, the inner peripheral end 23 of the resin frame member 22 is formed in a quadrangular annular shape around the outer peripheral portion of the MEA 20. It should be noted that the inner peripheral end 23 of the resin frame member 22 is a portion forming an inner end 22i of the resin frame member 22 and an area in the vicinity of the inner end 22i of the resin frame member 22.

As shown in FIG. 2, the inner peripheral end 23 of the resin frame member 22 is disposed between the outer peripheral portion 27 of the anode 26 and the outer peripheral portion 29 of the cathode 28. Specifically, the inner peripheral end 23 of the resin frame member 22 is held between the outer peripheral portion 25 of the electrolyte membrane 24 and the outer peripheral portion 29 of the cathode 28. It should be noted that the inner peripheral end 23 of the resin frame member 22 may be held between the outer peripheral portion 25 of the electrolyte membrane 24 and the outer peripheral portion of the anode 26.

In FIG. 3A, the inner peripheral end 23 of the resin frame member 22 includes four straight side parts 62 and four corner parts 64. As shown in FIGS. 2 and 3A, each of the side parts 62 has a tapered shape, i.e., being gradually narrowed toward the inside of the resin frame member 22. Stated otherwise, the thickness (i.e., the dimension in the direction indicated by the arrow A) of each of the side parts 62 is decreased toward the inside of the resin frame member 22. Each of the side parts 62 has a triangular shape in lateral cross section. That is, each of the side parts 62 includes an inclined surface 66 which is inclined inward from one surface 22a to the other surface 22b of the resin frame member 22, and a pair of side surfaces 68 coupled to respective both sides of the inclined surface 66 (see FIG. 3A). The inclined surface 66 is a flat surface.

As shown in FIG. 2, the inclination angle θ of the inclined surface 66 (angle formed between the other surface 22b of the resin frame member 22 and the inclined surface 66) is, for example, preferably, not more than 45°; more preferably, not less than 15° and not more than 30°; and still more preferably, about 20°. The inclination angle θ can be determined as necessary. The four side parts 62 have the same inclination angle θ. It should be noted that the four side parts 62 may have different inclination angles θ.

The inclined surface 66 extends over the entire length of each of side parts 62 (see FIG. 3A). It should be noted that the inclined surface 66 may be provided only on a portion of each of the side parts 62 in a direction in which the side parts 62 extend. The inclined surface 66 faces the surface 24b of the electrolyte membrane 24. Stated otherwise, the inclined surface 66 is positioned close to or in contact with the surface 24b of the electrolyte membrane 24. The thickness of each of the side parts 62 is reduced inward. Therefore, the gap S formed inside each of the side parts 62 is small in comparison with the case where each of the side parts 62 does not include any inclined surface 66 (i.e., in the case where each of the side parts 62 has a quadrangular shape in lateral cross section).

In FIG. 3A, each of the side surfaces 68 is coupled to an end of the inclined surface 66 in a direction which the inclined surface 66 extends. Each of the side surfaces 68 is positioned at an end of each of the side parts 62 in a direction in which the side parts 62 extend. The corner part 64 is formed by the side surfaces 68 that are adjacent to each other. The angle between the two side surfaces 68 forming the corner part 64 is about 90°. Each of the side surfaces 68 has a triangular shape. Each of the corner parts 64 protrudes toward one surface of the resin frame member 22 from the inclined surface 66. In the side part 62 and the corner part 64 of the inner peripheral end 23 that are adjacent to each other, a step (side surface 68) is formed between the inclined surface 66 and a portion (first plane surface part 65) positioned at the corner part 64, of one surface 22a of the resin frame member 22. The first plane surface part 65 of the corner part 64 is flush with a portion (second plane surface part 67) of one surface 22a of the resin frame member 22 that is positioned outside the inner peripheral end 23.

As shown in FIGS. 3A and 3B, each of the corner parts 64 has substantially constant thickness toward the inside of the resin frame member 22, up to the inner end 22i of the resin frame member 22. Each of the corner parts 64 has a quadrangular shape (rectangular shape) in lateral cross section (see FIG. 3B). The thickness of each of the corner parts 64 is larger than the thickness of a portion of the inner peripheral end 23 where the inclined surface (slope) 66 is formed. In each of corner parts 64, one surface 22a of the resin frame member 22 and the other surface 22b of the resin frame member 22 extend in parallel to each other. That is, each of the corner parts 64 has no inclined surface 66.

As shown in FIG. 2, the outer peripheral portion 25 of the electrolyte membrane 24 includes a first inclined area 70a formed on a portion thereof facing the inclined surface 66 of the resin frame member 22. The first inclined area 70a extends substantially in parallel to the inclined surface 66 of the resin frame member 22. In the electrolyte membrane 24, a surface 70b facing the anode 26 which is positioned outside the first inclined area 70a is separated from the cathode 28, in comparison with a surface 70c facing the anode 26 which is positioned inside the first inclined area 70a.

A second inclined area 72a is formed in the outer peripheral portion 27 of the anode 26 in a portion facing the first inclined area 70a of the electrolyte membrane 24. The second inclined area 72a extends substantially in parallel to the inclined surface 66 of the resin frame member 22. In the anode 26, the surface 72b closer to the first separator 16 positioned outside the second inclined area 72a is spaced from the cathode 28, in comparison with the surface 72c of the first separator 16 positioned inside the second inclined area 72a.

A third inclined area 74a is formed in the outer peripheral portion 29 of the cathode 28, at a position overlapped with the inclined surface 66 of the resin frame member 22, in the thickness direction (direction indicated by the arrow A) of the resin frame member 22. The third inclined area 74a is inclined toward the outer peripheral end 28o of the cathode 28, opposite to the side where the resin frame member 22 is positioned. In the cathode 28, the surface 74b of the second separator 18 positioned outside the third inclined area 74a is spaced from the anode 26 in comparison with the surface 74c closer to the second separator 18 positioned inside the third inclined area 74a.

Next, operation of the fuel cell stack 12 including the power generation cell 10 according to the embodiment of the present invention will be described below.

As shown in FIG. 1, an oxygen-containing gas is supplied to the oxygen-containing gas supply passage 30a, and a fuel gas such as a hydrogen-containing gas is supplied to the fuel gas supply passage 34a. Further, a coolant such as pure water, ethylene glycol, or oil is supplied to the coolant supply passage 32a.

Therefore, the oxygen-containing gas flows from the oxygen-containing gas supply passage 30a into the oxygen-containing gas flow field 46 of the second separator 18, and moves in the direction indicated by the arrow B, and the oxygen-containing gas is supplied to the cathode 28 of the MEA 20. In the meanwhile, the fuel gas flows from the fuel gas supply passage 34a into the fuel gas flow field 36 of the first separator 16. The fuel gas flows along the fuel gas flow field 36 in the direction indicated by the arrow B, and the fuel gas is supplied to the anode 26 of the MEA 20.

Thus, in each of the MEAs 20, the oxygen-containing gas supplied to the cathode 28 and the fuel gas supplied to the anode 26 are consumed in the electrochemical reactions to perform power generation.

Then, in FIG. 1, the oxygen-containing gas supplied to the cathode 28 is discharged along the oxygen-containing gas discharge passage 30b in the direction indicated by the arrow A. Likewise, the fuel gas supplied to the anode 26 is consumed at the anode 26, and the fuel gas is discharged along the fuel gas discharge passage 34b in the direction indicated by the arrow A.

Further, the coolant supplied to the coolant supply passage 32a flows into the coolant flow field 56 between the first separator 16 and the second separator 18, and thereafter, flows in the direction indicated by the arrow B. After the coolant cools the MEA 20, the coolant is discharged from the coolant discharge passage 32b.

Next, a method of producing the resin frame equipped MEA 14 according to the embodiment of the present invention will be described below.

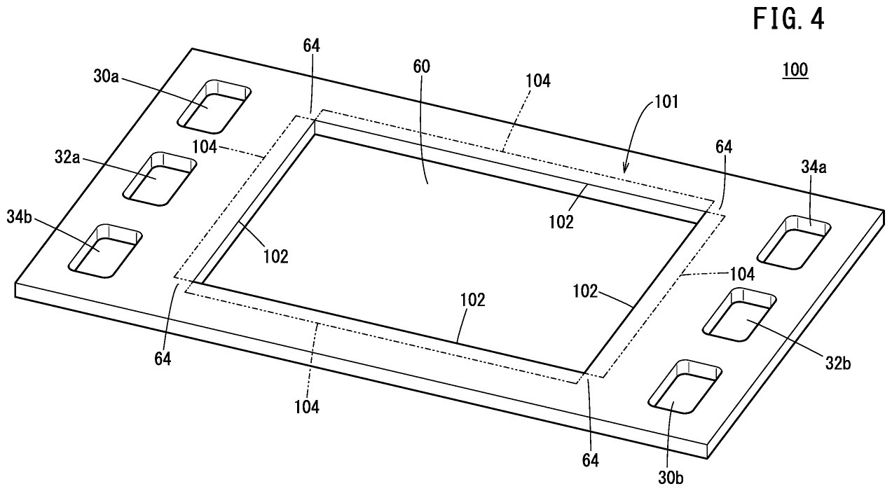

Firstly, a resin sheet 100 shown in FIG. 4 is produced. At one end of the resin sheet 100 in the longitudinal direction, the oxygen-containing gas supply passage 30a, the coolant supply passage 32a, and the fuel gas discharge passage 34b are formed. At the other end of the resin sheet 100 in the longitudinal direction, the fuel gas supply passage 34a, the coolant discharge passage 32b, and the oxygen-containing gas discharge passage 30b are formed. Further, the quadrangular opening 60 is formed at the central portion of the resin sheet 100.

Next, the inclined surface 66 shown in FIG. 3A is processed (formed) in each of side parts 102 of an inner peripheral end 101 of the resin sheet 100 (portion indicating a virtual line 104 of the resin sheet 100 is processed). At this time, each of the corner parts 64 of the inner peripheral end 101 of the resin sheet 100 is not processed. That is, each of the corner parts 64 of the inner peripheral end 101 of the resin sheet 100 is left as it is.

Specifically, the inclined surface 66 (see FIG. 3A) is formed by laser machining, water jet machining, press machining (cutting using die trimming), cutting using a blade, etc. For example, in the case of using laser machining, by scanning a laser beam from one end to the other end of each of the side parts 102, it is possible to form the inclined surface 66. As described above, since no processing (machining) of the corner part 64 of the inner peripheral end 101 of the resin sheet 100 is required, it is possible to produce the resin frame member 22 easily.

Next, the anode 26 provided with the electrolyte membrane 24, and the cathode 28 are prepared. Then, the inner peripheral end 23 of the resin frame member 22 is disposed between the outer peripheral portion 25 of the electrolyte membrane 24 and the outer peripheral portion 29 of the cathode 28 to join the electrolyte membrane 24, the cathode 28, and the resin frame member 22 together. Specifically, by heating and applying a load (hot pressing) to the anode 26, the electrolyte membrane 24, the resin frame member 22, and the cathode 28 that are stacked together, these components are joined together. Thus, the resin frame equipped MEA 14 is obtained.

The resin frame equipped MEA 14 and the power generation cell 10 according to the embodiment of the present invention offers the following advantages.

The inner peripheral end 23 of the resin frame member 22 is formed in a quadrangular annular shape around the outer peripheral portion of the MEA 20, and disposed between the outer peripheral portion 27 of the anode 26 and the outer peripheral portion 29 of the cathode 28. The inclined surface 66 is formed on each of four side parts 62 of the inner peripheral end 23. The inclined surface is inclined inward from one surface 22a of the resin frame member 22 toward the other surface 22b of the resin frame member 22. In the side part 62 and the corner part 64 of the inner peripheral end 23 that are adjacent to each other, the step (side surface 68) is formed between the inclined surface 66 and the portion (first plane surface part) 65 positioned at the corner part 64, of the one surface 22a of the resin frame member 22.

In the structure, the inclined surface 66 is formed on each of the four side parts 62 of the inner peripheral end 23 of the resin frame member 22. That is, the thickness of the inner peripheral end 23 of the resin frame member 22 is reduced inward. Therefore, it is possible to reduce the size of the gap S inside the inner peripheral end 23 of the resin frame member 22. Thus, it is possible to improve the power generation efficiency. Further, in the side part 62 and the corner part 64 of the inner peripheral end 23 that are adjacent to each other, the step is formed between the first plane surface part 65 and the inclined surface 66. Therefore, since no inclined surfaces 66 need to be formed at the four corner parts 64 of the inner peripheral end 23 of the resin frame member 22, it is possible to suppress decrease in the production efficiency of the resin frame member 22.

The inclined surface 66 faces the electrolyte membrane 24.

In the structure, it is possible to prevent each of the side parts 62 of the resin frame member 22 from sticking into the electrolyte membrane 24. Accordingly, it is possible to suppress damage to the electrolyte membrane 24.

The four side parts 62 have the same inclination angle (θ) of the inclined surface 66 which is inclined from a planar direction of the resin frame member 22 (i.e., the inclination angle with respect to the planar direction).

In the structure, it is possible to further increase the production efficiency of producing the resin frame member 22.

The present invention is not limited to the above described embodiment, and various modifications can be made without departing from the gist of the present invention. In the resin frame equipped MEA 14, the inclined surface 66 may be oriented opposite to the electrolyte membrane 24.

The above embodiment can be summarized as follows:

The above embodiment discloses the resin frame equipped membrane electrode assembly (14). The resin frame equipped membrane electrode assembly includes the membrane electrode assembly (20) and the resin frame member (22). The membrane electrode assembly includes the electrolyte membrane (24), the first electrode (26) provided on one surface (24a) of the electrolyte membrane, and the second electrode (28) provided on the other surface (24b) of the electrolyte membrane. The resin frame member is provided on an outer peripheral portion of the membrane electrode assembly. The inner peripheral end (23) of the resin frame member is formed in a quadrangular annular shape around the outer peripheral portion of the membrane electrode assembly and disposed between the outer peripheral portion of the first electrode and the outer peripheral portion of the second electrode. The inclined surface (66) is formed on each of four side parts (62) of the inner peripheral end. The inclined surface is inclined inward from one surface (22a) of the resin frame member toward the other surface (22b) of the resin frame member. In the side part and the corner part (64) of the inner peripheral end that are adjacent to each other, the step (68) is formed between the inclined surface and the portion (65) positioned at the corner part, of the one surface of the resin frame member.

In the resin frame equipped membrane electrode assembly, the inclined surface may be configured to face the electrolyte membrane.

In the resin frame equipped membrane electrode assembly, the four side parts may have the same inclination angle (θ) of the inclined surface with respect to a planar direction of the resin frame member.

In the resin frame equipped membrane electrode assembly, the surface size of one electrode (26) of the first electrode and the second electrodes may be larger than the surface size of the other electrode (28) of the first electrode and the second electrode.

In the resin frame equipped membrane electrode assembly, each of the four side parts may have a triangular shape in lateral cross section.

In the resin frame equipped membrane electrode assembly, the inclined surface may extend over the entire length of each of the four side parts.

In the resin frame equipped membrane electrode assembly, the corner part may have a quadrangular shape in lateral cross section.

The above embodiment discloses the power generation cell (10) including the above described resin frame equipped membrane electrode assembly, and the first separator (16) and the second separator (18) provided respectively on both sides of the resin frame equipped membrane electrode assembly.

What is claimed is:

1. A resin frame equipped membrane electrode assembly comprising:
a membrane electrode assembly including an electrolyte membrane, a first electrode provided on one surface of the electrolyte membrane, a second electrode provided on another surface of the electrolyte membrane; and
a resin frame member provided on an outer peripheral portion of the membrane electrode assembly,
wherein an inner peripheral end of the resin frame member is formed in a quadrangular annular shape around the outer peripheral portion of the membrane electrode assembly and disposed between an outer peripheral portion of the first electrode and an outer peripheral portion of the second electrode;
an inclined surface is formed on each of four side parts of the inner peripheral end, the inclined surface being inclined inward from one surface of the resin frame member toward another surface of the resin frame member; and
in a side part and a corner part of the inner peripheral end that are adjacent to each other, a step is formed between the inclined surface and a portion positioned at the corner part, of the one surface of the resin frame member.

2. The resin frame equipped membrane electrode assembly according to claim 1, wherein the inclined surface is configured to face the electrolyte membrane.

3. The resin frame equipped membrane electrode assembly according to claim 1, wherein the four side parts have a same inclination angle of the inclined surface with respect to a planar direction of the resin frame member.

4. The resin frame equipped membrane electrode assembly according to claim 1, wherein a surface size of one electrode of the first electrode and the second electrodes is larger than a surface size of another electrode of the first electrode and the second electrode.

5. The resin frame equipped membrane electrode assembly according to claim 1, wherein each of the four side parts has a triangular shape in lateral cross section.

6. The resin frame equipped membrane electrode assembly according to claim 1, wherein the inclined surface extends over an entire length of each of the four side parts.

7. The resin frame equipped membrane electrode assembly according to claim 1, wherein the corner part has a quadrangular shape in lateral cross section.

8. A power generation cell comprising:
a resin frame equipped membrane electrode assembly; and
a first separator and a second separator provided on both sides of the resin frame equipped membrane electrode assembly, respectively,
the resin frame equipped membrane electrode assembly comprising:
a membrane electrode assembly including an electrolyte membrane, a first electrode provided on one surface of the electrolyte membrane, a second electrode provided on another surface of the electrolyte membrane; and
a resin frame member provided on an outer peripheral portion of the membrane electrode assembly,
wherein an inner peripheral end of the resin frame member is formed in a quadrangular annular shape around the outer peripheral portion of the membrane electrode assembly and disposed between an outer peripheral portion of the first electrode and an outer peripheral portion of the second electrode,
an inclined surface is formed on each of four side parts of the inner peripheral end, the inclined surface being inclined inward from one surface of the resin frame member toward another surface of the resin frame member; and
in a side part and a corner part of the inner peripheral end that are adjacent to each other, a step is formed between the inclined surface and a portion positioned at the corner part, of the one surface of the resin frame member.

9. The power generation cell according to claim 8, wherein the inclined surface is configured to face the electrolyte membrane.

10. The power generation cell according to claim 8, wherein the four side parts have a same inclination angle of the inclined surface with respect to a planar direction of the resin frame member.

11. The power generation cell according to claim 8, wherein a surface size of one electrode of the first electrode and the second electrodes is larger than a surface size of another electrode of the first electrode and the second electrode.

12. The power generation cell according to claim 8, wherein each of the four side parts has a triangular shape in lateral cross section.

13. The power generation cell according to claim 8, wherein the inclined surface extends over an entire length of each of the four side parts.

14. The power generation cell according to claim 8, wherein the corner part has a quadrangular shape in lateral cross section.
